(19) United States
(12) Patent Application Publication
(10) Pub. No.: US 2011/0066579 A1
(43) Pub. Date: Mar. 17, 2011

(54) Neural network system for time series data prediction

(75) Inventor: Satoshi Ikada, Nara (JP)

(73) Assignee: OKI ELECTRIC INDUSTRY CO., LTD., Tokyo (JP)

(21) Appl. No.: 12/805,999

(22) Filed: Aug. 27, 2010

(30) Foreign Application Priority Data
Sep. 16, 2009 (JP) 2009-214643

(51) Int. Cl. G06N 3/02

(52) U.S. Cl. 706/21

(57) ABSTRACT

A neural network system for predicting time series data. The system receives analyzed data obtained by multiresolution analysis of the time series data. The input processing layer of the system includes a series of neurons corresponding to the different levels of analysis, each neuron receiving the analyzed data for it own level. The output of each of these neurons is supplied as an additional input to the neuron for the next lower level of analysis. A predicted value is derived from the output of the neuron at the lowest level. The passing of results from one level to another improves prediction accuracy and simplifies the structure of any further processing layers.

### BACKGROUND OF THE INVENTION

1. Field of the Invention

The present invention relates to a neural network system for predicting time series data with increased accuracy.

2. Description of the Related Art

Accurate prediction of future values of time series data such as stock prices, vehicular traffic volumes, communication traffic volumes, and other values that vary with time is necessary in order to prepare for impending events or detect abnormal behavior. One known method of time series prediction is to create a mathematical model such as an autoregressive moving-average (ARMA) model or a neural network model and train the model on existing data.

It is known that neural networks can perform flexible information processing tasks that would be difficult for a conventional von Neumann type computer. Many types of neural network systems have been proposed.

For example, in Japanese Patent Application Publication No. H06-175998 (FIG. 1) Ohara proposes a method in which past and current time series patterns are input to a neural network consisting of an input layer, an intermediate layer, an output layer, and a context layer, back-propagation is carried out to train the neural network, and the trained neural network is used for time series prediction. A problem with this method is that when the time series data vary in intricate and ever-changing ways, adequate feature vectors for training the model cannot be obtained, leading to predictions of low accuracy.

In Japanese Patent Application Publication No. H11-212947 (now Japanese patent No. 3567073), Shiromaru et al. propose a neural network model in which the input time series data are first analyzed (filtered) to express the data as a sum of high, medium, and low frequency components. Each frequency component is input to a separate neural network with input, intermediate, and output layers. The predictions made by the separate neural networks are added together to obtain a final prediction. This method provides more accurate predictions than Ohara's method, but since each neural network is trained independently, it is not possible to train the system to predict the behavior of one frequency component from the behavior of another frequency component.

Analyzing a time series into frequency components is one type of multiresolution analysis, the different frequency components representing different levels of analysis. It would be desirable to have a neural network system that could be trained to predict time series data by treating the behavior of the time series at different levels of analysis as interrelated phenomena instead of as independent phenomena.

### SUMMARY OF THE INVENTION

An object of the present invention is to predict time series data more accurately.

The invention provides a novel neural network system for this purpose.

The input unit of the system receives analyzed data obtained by multiresolution analysis of the time series data. The analyzed data include data for different levels of analysis, from a highest level to a lowest level, indicating frequency characteristics of the time series data.

The analyzed data are processed by a processing unit including at least an input processing layer. The input processing layer generates output data by operating on the analyzed data received for a descending series of levels, starting from the highest level, to obtain an output value for each level in the series. At each level below the highest level, the output value is obtained by operating on the analyzed data of that level and the output value obtained from the next higher level in the series.

The series of levels may include all levels from the highest level to the lowest level.

The data output by the input processing layer may be the output value obtained at the lowest level in the series. Alternatively, the input unit may also receive correlated data related to the time series data, and the processing unit may also include a correlated data processing section that processes the correlated data and the output value obtained at the lowest level in the series to obtain the output data.

The novel apparatus may also include an intermediate processing layer that processes the output data obtained by the input processing layer over a predetermined most recent interval of time. The output of the intermediate processing layer may then be further processed to generate the predicted value.

The multiresolution analysis may be a wavelet analysis and the analyzed data may include wavelet coefficients.

By interrelating the different levels of analysis in the input processing layer, the novel apparatus can produce more accurate predicted values than conventional apparatus.

If the multiresolution analysis is a wavelet analysis, the multiresolution analysis can be carried out quickly.

Since most of the processing is completed in the input processing layer, the intermediate processing layer and any further processing layers can have a simple structure.

### BRIEF DESCRIPTION OF THE DRAWINGS

In the attached drawings:

FIG. 1 illustrates the structure of a neural network system for time series data prediction;

FIG. 2 illustrates processing in a delay processing unit in FIG. 1;

FIG. 3 illustrates a Haar scaling function;

FIG. 4 illustrates mother wavelets used for analysis;

FIG. 5 illustrates the calculation of wavelet coefficients;

FIG. 6 schematically illustrates a neuron in a neural network;

FIG. 7 is a graph comparing conventional and novel predicted values with observed values; and

FIG. 8 shows the mean square errors of the predicted values in FIG. 7 with respect to the observed values.

### DETAILED DESCRIPTION OF THE INVENTION

As an embodiment of the invention, a novel neural network system for predicting time series data will now be described with reference to the attached drawings, in which like elements are indicated by like reference characters.

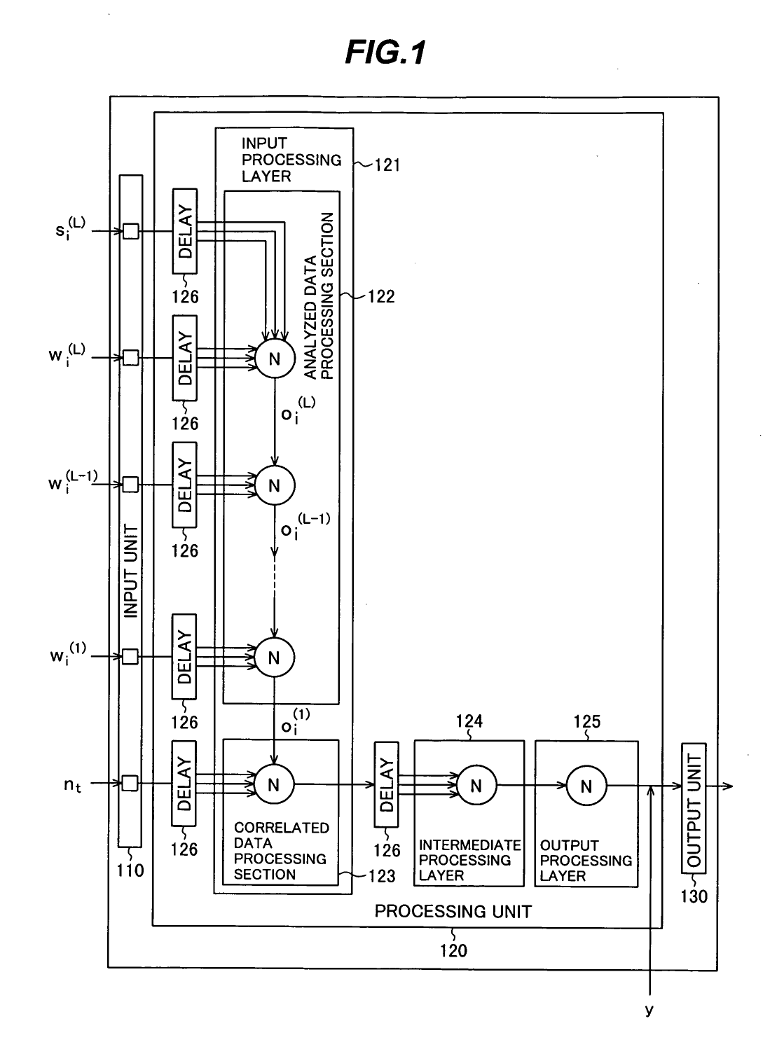

Referring to FIG. 1, the neural network system 100 includes an input unit 110, a processing unit 120, and an output unit 130.

The input unit 110 receives analyzed data and outputs the data in a form that can be processed by the processing unit 120. The analyzed data have been generated by multiresolution analysis (MRA) of the time series data. More specifically, the analyzed data are wavelet coefficients w^{(L)}ᵢ to w⁽¹⁾ᵢ obtained by wavelet analysis of the time series data. The input unit 110 also receives the scaling coefficients s^{(L)}ᵢ for the highest wavelet analysis level and correlated data nₜ. The correlated data nₜ are arbitrary data related to the time series data.

The processing unit 120 processes the data received by the input unit 110 to generate an output value that is supplied to the output unit 130 as a prediction of the next value in the time series. The processing unit 120 is a model-based learner incorporating a neural network that has been trained on previous time series data. The neural network is a network of processing elements conventionally referred to as neurons, because they are modeled on neurons in the brain. Each neuron, indicated as a circled N in the drawing, generates an output value by a process including weighted addition of multiple inputs. The output value may become an input to another neuron.

The neural network is trained by back propagation. This well known training algorithm takes the difference between predicted values calculated by the processing unit 120 and known correct answer data y, calculates local error values representing the difference between the actual and desired outputs of each neuron, and adjusts the weighting coefficients of the neurons so as to reduce the local differences, proceeding in reverse order to the order of processing followed in the prediction process.

The processing unit 120 includes an input processing layer 121, an intermediate processing layer 124, an output processing layer 125, and a plurality of delay processing units 126. The input processing layer 121 includes an analyzed data processing section 122 and a correlated data processing section 123.

The analyzed data processing section 122 processes the input wavelet coefficients and scaling coefficients. The processing is done by a series of neurons, including one neuron for each level in the wavelet analysis that produced the wavelet coefficients. The neurons are interconnected in descending order of level, corresponding to ascending order of frequency. The first neuron in the series receives the wavelet coefficients and scaling factors for the highest wavelet analysis level, representing the lowest analyzed frequency component of the time series. Each other neuron in the series receives the wavelet coefficients for its own level and the output of the preceding neuron in the series.

The correlated data processing section 123 receives the output of the last neuron in the analyzed data processing section 122, which processed the highest-frequency wavelet coefficients, and the correlated data nₜ. The correlated data processing section 123 consists of a single neuron, which produces the output of the input processing layer 121.

The operations performed in the input processing layer 121 will be described in more detail later.

The intermediate processing layer 124 and output processing layer 125 consist of one neuron each. The intermediate processing layer 124 operates on a certain number of consecutive outputs of the input processing layer 121, which are held in a delay processing unit 126. The output processing layer 125 operates on the output of the intermediate processing layer 124, and provides the final output of the processing unit 120 as a predicted time series value to the output unit 130. The output unit 130 converts the final output to an appropriate signal that is supplied to, for example, an external device (not shown).

The delay processing units 126 store data temporarily. At any given time t, the delay processing units 126 store the data needed by the neurons to calculate a predicted value for the time series at time t+1.

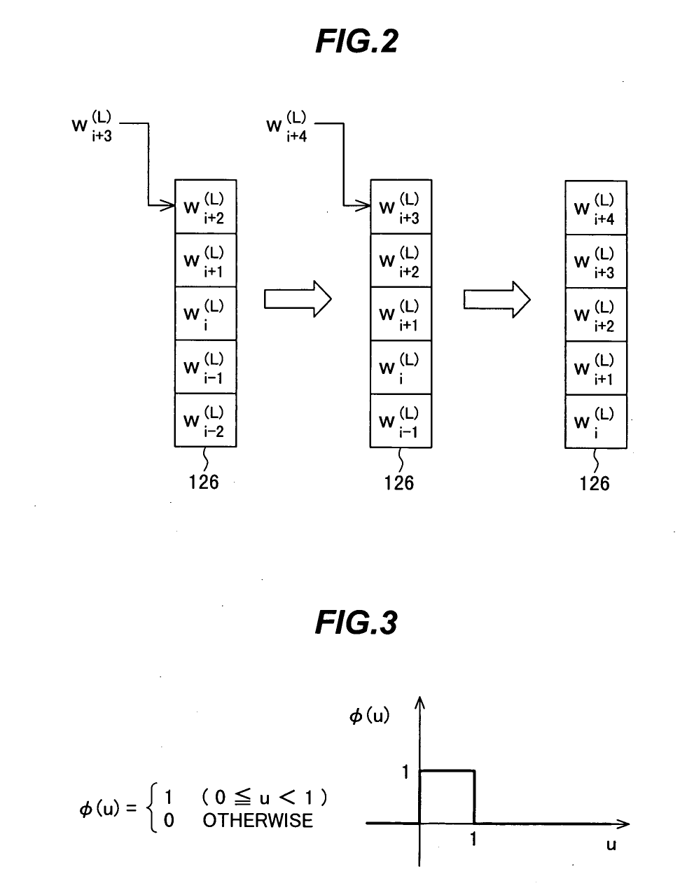

Referring to FIG. 2, the delay processing units 126 have a first-in-first-out (FIFO) structure in which new input data displace the oldest stored data. For example, if a delay processing unit 126 currently holds wavelet coefficients w^{(L)}ᵢ₊₂ to w^{(L)}ᵢ₋₂, where i represents time, when the next coefficient w^{(L)}ᵢ₊₃ is received, the oldest coefficient w^{(L)}ᵢ₋₂ is discarded and the stored coefficients become w^{(L)}ᵢ₊₃ to w^{(L)}ᵢ₋₁. Similarly, when w^{(L)}ᵢ₊₄ is received, w^{(L)}ᵢ₋₁ is discarded, the stored coefficients becoming w^{(L)}ᵢ₊₄ to w^{(L)}ᵢ. Each delay processing unit 126 therefore stores a fixed quantity of data, representing a certain time interval extending back from the present.

The processing unit 120 may be configured from specialized hardware, or from general-purpose computing and control hardware, such as a computer including a central processing unit (CPU), that executes programs stored as software or firmware to implement the processing performed by the neurons and delay units in FIG. 1. The instruction data and other data for these programs may be stored in a storage unit (not shown). Alternatively, the processing unit 120 may include a network of separate processing elements, each operating as a single neuron, interconnected by communication links. The neural network system 100 will be described in this way, by treating each neuron as a unit processing element.

Next, the operation of the neural network system 100 will be described. In a stage preceding the neural network system 100, a wavelet transformation is carried out on sampled and quantized time series data to obtain wavelet coefficients and scaling coefficients that represent the result of multiresolution analysis.

The wavelet coefficients are related to the original time series signal f (t) as follows, where t is a time variable and L represents the highest level of analysis.

$$f ( t ) = {\sum }_{j = 1}^{L} {g}_{j} ( t ) + {f}_{L} ( t ) \qquad ( 1 )$$

The quantity gⱼ(t) in equation (1) can be expressed in terms of wavelet coefficients w_{j, k} and mother wavelets ψ_{j, k} as in equation (2). The quantity f_{L}(t) in equation (1) can be expressed in terms of scaling coefficients s_{L, k} and mother wavelets ψ_{L, k} for analysis level L as in equation (3).

$$\begin{matrix}{g}_{j} ( t ) = {\sum }_{k} {w}_{j , k} \cdot {ϕ}_{j , k} ( t ) & ( 2 ) \\ {f}_{L} ( t ) = {\sum }_{k} {s}_{L , k} \cdot {ϕ}_{L , k} ( t ) & ( 3 )\end{matrix}$$

The scaling function is the Haar function φ(u) shown in FIG. 3, which takes the value 1 in the unit interval (0≦u<1) and the value 0 elsewhere.

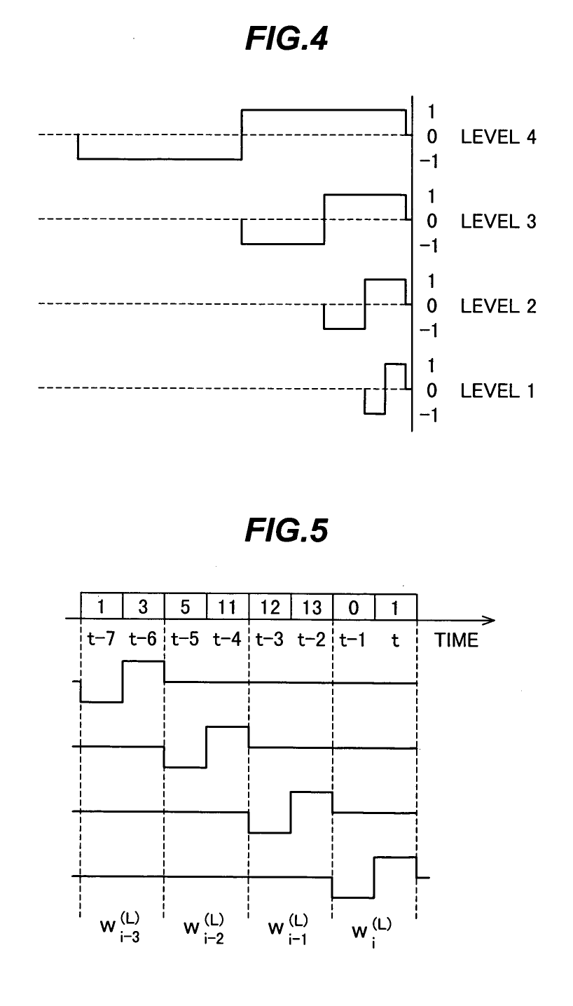

A family of mother wavelets derived from the Haar function for four levels of wavelet analysis is shown in FIG. 4. The wavelet coefficients are obtained as inner products of the mother wavelets and the time series data, divided by the scaling coefficients. Wavelet coefficients for different levels are obtained by varying the width of the mother wavelet as shown in FIG. 4.

The calculation of wavelet coefficients for time series data {1, 3, 5, 11, 12, 13, 0, 1} corresponding to times t−7 to t is illustrated in FIG. 5. At the first level of analysis (level 1), inner products are taken with the mother wavelet (−1, 1), followed by scaling. Successive wavelet coefficients are calculated by sliding the mother wavelet in the time direction. For example, the inner product of the time series data (1, 3) and the mother wavelet (−1, 1) is

{1×(−1)}+{3×1 }=2.

The scaling coefficient is 2^{1/2} so the wavelet coefficient is 2/2^{1/2}=2^{1/2}=1.4142, shown as w⁽¹⁾ᵢ₋₃ in FIG. 5. Wavelet coefficients for (5, 11), (12, 13), and (0, 1) are calculated similarly. The complete set of four wavelet coefficients for level 1 is {w⁽¹⁾ᵢ₋₃=1.4142, w⁽¹⁾ᵢ₋₂=4.2426, w⁽¹⁾ᵢ₋₁=0.7071, w⁽¹⁾ᵢ=0.7071}. Wavelet coefficient w⁽¹⁾ᵢ corresponds to time t.

At the second level of analysis (level 2), the width of the mother wavelet is doubled to (−1, −1, 1, 1), its inner product with four time series data values is taken, and the result is divided by a scaling coefficient equal to 4.

The wavelet coefficients calculated in this way are input to the input unit 110 together with the highest-level scaling coefficient. The input unit 110 processes these inputs and sends the resulting signals as data to the processing unit 120. Similar signal processing is carried out on the correlated data nₜ. The data output by the input unit 110 are temporarily stored in delay processing units 126 as explained above. These delay processing units 126 accordingly store the wavelet coefficients, scaling coefficients, and correlated data nₜ received over a certain interval extending back from time t.

The analyzed data processing section 122 in the processing unit 120 operates on the wavelet coefficients and scaling coefficients held in the delay processing units 126, using a separate neuron for each level of analysis.

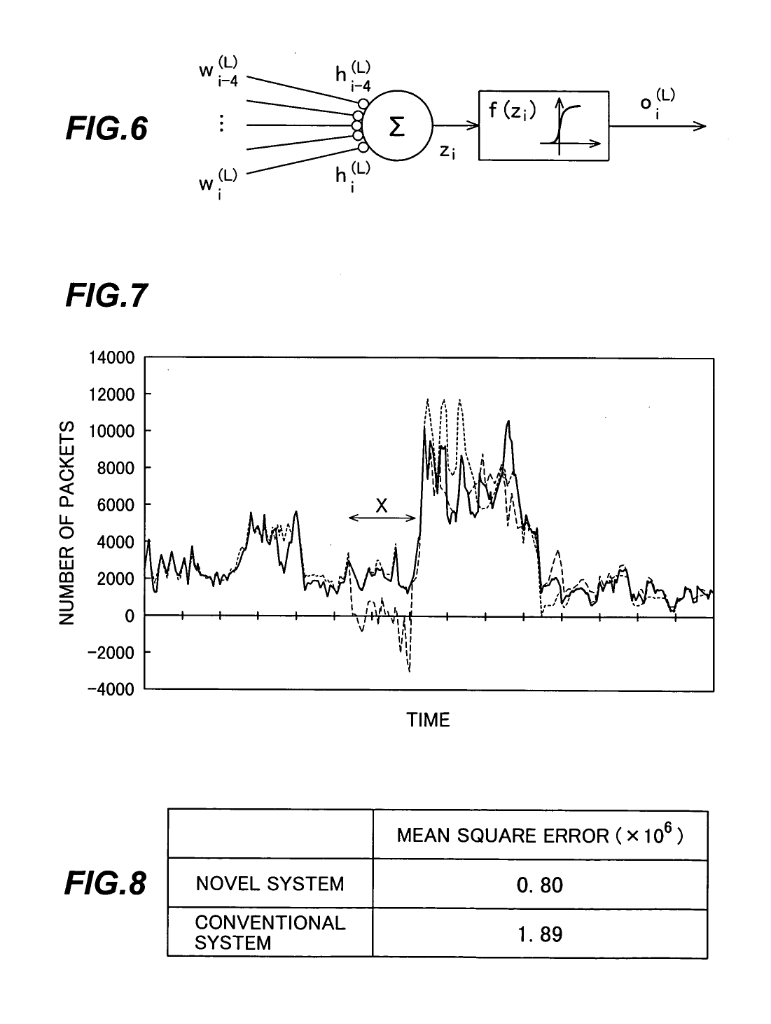

A general neuron can be represented as in FIG. 6. The neuron in FIG. 6 receives wavelet coefficients w^{(L)}ᵢ, w^{(L)}ᵢ₋₁, w^{(L)}ᵢ₋₂, w^{(L)}ᵢ₋₃, w^{(L)}ᵢ₋₄, multiples them by respective weighting coefficients h^{(L)}ᵢ, h^{(L)}ᵢ₋₁, h^{(L)}ᵢ₋₂, h^{(L)}ᵢ₋₃, h^{(L)}₁₋₄, and adds the resulting products to obtain a sum zᵢ. This sum zᵢ is substituted into a transfer function f such as, for example, a preselected sigmoid function to obtain the output value oᵢ of the neuron, as indicated by equation (4).

$${o}_{i} = f ( {\sum }_{j = i - 4}^{i} {h}_{j} \cdot {w}_{j} ) \qquad ( 4 )$$

First the top level neuron in the analyzed data processing section 122 in FIG. 1 obtains an output value o^{(L)}ᵢ for the highest level of analysis (level L) by operating in this way on the wavelet coefficients and scaling coefficients for the highest level. The scaling coefficients were omitted for simplicity from FIG. 6 and equation (4), but they are processed in the same way as the wavelet coefficients. The output value o^{(L)}ᵢ is input to the next lower neuron, on level L−1.

The neuron on level L-1 also receives the wavelet coefficients w^{(L-1)}ᵢ etc. for this level and carries out a similar operation to obtain an output value o^{(L-1)}ᵢ, which is supplied to the neuron on the next lower level (L-2). This process continues until an output value o⁽¹⁾ᵢ is obtained for the lowest level as the output of the analyzed data processing section 122.

Owing to this passing of output values from higher-level neurons to lower-level neurons in the analyzed data processing section 122, each neuron can incorporate the results of the calculations carried out on the higher levels into its own calculations, so that the predictions made for the different levels of analysis are interrelated.

The data o⁽¹⁾ᵢ output from the analyzed data processing section 122 is supplied to the correlated data processing section 123. The correlated data processing section 123 also receives correlated data for a certain interval of time extending back from the current time t, these data being stored in another delay processing unit 126. In the prediction of packet traffic volume under the real-time transport protocol (RTP), for example, the correlated data nₜ may be the number of session initiation protocol (SIP) packets transmitted during the interval of time, SIP packets being call control packets transmitted when a communication session begins. Alternatively, the correlated data may be the number of sessions, or the current time. The neuron in the correlated data processing section 123 processes the correlated data and the output data o⁽¹⁾ᵢ received from the analyzed data processing section 122 in the general manner illustrated in FIG. 6, by calculating a weighted sum and applying a transfer function. In this embodiment the output value produced by the correlated data processing section 123 is the final output of the input processing layer 121.

The data output from the input processing layer 121 over a predetermined interval of time are temporarily stored in yet another delay processing unit 126, and supplied to the intermediate processing layer 124.

The intermediate processing layer 124 in this embodiment has a single neuron that operates on the data stored in the delay processing unit 126, and produces a predicted time series value for time t+1. This predicted value is supplied to the output unit 130 and placed in, for example, a signal sent to an external device (not shown).

Time series values predicted by the novel neural network system 100 are compared with observed values and values predicted by a conventional apparatus in FIG. 7. The observed values are communication packet traffic values on an electrical communication network. The vertical axis represents number of packets and the horizontal axis represents time. The values predicted by the conventional apparatus (dashed curve) deviate considerably from the observed values (dotted curve), particularly during a span of time X in which the conventional apparatus produces impossibly low predicted values. The values predicted by the novel apparatus 100 (solid curve) follow the observed values quite accurately during this interval, and on the whole are closer to the observed values than are the values predicted by the conventional apparatus.

The mean square error of the predicted values in FIG. 7 is shown in FIG. 8. By this measure, the predictions made by the novel apparatus 100 are more than twice as accurate as the predictions made by the conventional apparatus.

The basic reason for the improved prediction accuracy of the novel apparatus is thought to be that each level of analysis makes use of the prediction results at higher levels of analysis. Another factor is that similar use of the prediction results at higher levels is made during the training of the neural network. A further factor is the provision of a correlated data processing section that modifies the prediction made by the analyzed data processing section according to correlated data.

An advantage of the use of a wavelet transformation to perform the multiresolution analysis and the use of wavelet coefficients as input data is that the multiresolution analysis process can be completed quickly, even if there are many levels of analysis.

The invention is not limited to the use of wavelets derived from the Haar function. Other types of wavelets may be used, or a type of multiresolution analysis other than wavelet analysis may be used.

It is not necessary to use all levels of the multilevel analysis. A level selection unit can be added to the novel neural network system. During the training process, the level selection unit selects the levels to use. If, for example, the highest level is level M and the level selection unit selects levels M-1, M-3, and M-4, then the neuron at level M uses the level-M wavelet coefficients and scaling coefficients to obtain an output value o^{(M)}, which is input to the neuron at level M-1; then the output o^{(M-1)} of the neuron at level M-1 is input to the neuron at level M-3, bypassing level M-2, the output o^{(M-3)} of the neuron at level M-3 is input to the neuron at level M-4, and the output o^{(M-4)} of the neuron at level M-3 is input to the correlated data processing section. The output o^{(M-2)} of the neuron at level M-2 is discarded.

Those skilled in the art will recognize that further variations are possible within the scope of the invention, which is defined in the appended claims.

1. A neural network system for processing time series data to calculate predicted time series values, comprising:
an input unit for receiving analyzed data obtained by multiresolution analysis of the time series data, the analyzed data including data for different levels of analysis, from a highest level of analysis to a lowest level of analysis, the different levels of analysis indicating different frequency characteristics of the time series data; and
a processing unit including an input processing layer for generating first output data by operating on the analyzed data for the highest level of analysis to obtain an output value for the highest level of analysis, then obtaining an output value for each level of analysis in a descending series of levels by operating, at each level of analysis in the descending series of levels, on the analyzed data of the each level of analysis and the output value obtained at the next higher level of analysis in the descending series of levels;
the predicted time series values being derived from the first output data.

2. The neural network system of claim 1, wherein higher levels of analysis represent lower frequency characteristics of the time series data.

3. The neural network system of claim 1, wherein the first output data are derived from the output value obtained at a lowest level of analysis in the descending series of levels.

4. The neural network system of claim 1, wherein the descending series of levels include all the levels of analysis from the highest level of analysis to the lowest level of analysis.

5. The neural network system of claim 1, wherein the input processing layer includes one neuron for each level of analysis.

6. The neural network system of claim 5, wherein:
the one neuron for the highest level of analysis calculates a weighted sum of the analyzed data for the highest level of analysis; and
the one neuron for each level of analysis below the highest level of analysis in the descending series of levels calculates a weighted sum of the analyzed data for the each level of analysis below the highest level of analysis and the output value obtained from the next higher level of analysis in the descending series of levels.

7. The neural network system of claim 6, wherein the one neuron for each level of analysis obtains the output value for the each level of analysis by applying a transfer function to the weighted sum.

8. The neural network system of claim 1, wherein the processing unit further includes at least one delay processing unit for receiving the analyzed data at different times, storing the analyzed data received over a predetermined most recent interval of time, and supplying the stored analyzed data to the input processing layer.

9. The neural network system of claim 1, wherein the processing unit further includes:
an intermediate processing layer for generating second output data by operating on the first output data; and
an output processing layer for generating third output data by operating on second output data, the predicted time series values being derived from the third output data.

10. The neural network system of claim 9, wherein the intermediate processing layer includes a single neuron that takes a weighted sum of a predetermined quantity of most recent first output data obtained from the input processing layer.

11. The neural network system of claim 10, further comprising a delay unit for storing the predetermined quantity of most recent first output data.

12. The neural network system of claim 1, wherein the multiresolution analysis is a wavelet-based frequency analysis, in which the level of analysis increases as the analyzed data are obtained from lower-frequency wavelets.

13. The neural network system of claim 12, wherein the analyzed data include wavelet coefficients.

14. The neural network system of claim 13, wherein:
the input unit also receives scaling coefficient data as analyzed data at the highest level of analysis; and
the processing unit operates on a combination of the wavelet coefficient data at the highest level of analysis and the scaling coefficient data.

15. The neural network system of claim 1, wherein:
the input unit also receives correlated data correlated with the analyzed data; and
the input processing layer also operates on a combination of the output value obtained at the lowest level of analysis in the descending series and the correlated data.

16. The neural network system of claim 1, wherein the neural network system is trained by back propagation.
